(19) United States
(12) Patent Application Publication
(10) Pub. No.: US 2010/0218475 A1
(43) Pub. Date: Sep. 2, 2010

(54) VINE OR CANE PRUNER

(76) Inventor: Walter Donald Langlois, Marlborough (NZ)

Correspondence Address: W LANGLOIS, 1 ALMA ST NTH, RENWICK, MARLBOROUGH, 7204, omitted

(21) Appl. No.: 12/668,422

(22) PCT Filed: Apr. 15, 2008
(86) PCT No.: PCT/NZ08/00082

§ 371 Date: May 12, 2010

(30) Foreign Application Priority Data
Aug. 10, 2007 (NZ) 560554

(51) Int. Cl. A01G 3/08; A01F 29/12

(52) U.S. Cl. 56/153

(57) ABSTRACT

A cane or vine pruning remover consists of abutting driven wheels which when moved along above vines or canes engage those rising between the wheels to strip them from the parent plant.

### TECHNICAL FIELD

The invention generally relates to pruning of vines or canes.

More particularly the invention relates to pruning of vines or canes which are supported in a planar manner, as for instance espalier.

### BACKGROUND ART

Vines or canes may be grown from plants where the fruiting vines or canes are supported in a single plane, typically on elongate members such as wire. Retraining and pruning of such vines or canes is a major job each winter especially if carried out by hand, with the removal of pruned canes from such a plant being a substantial obstacle.

Machines for pruning vines or canes are known and generally provide cutters which engage and cut vines or canes projecting from the plane in which the vines or canes are supported.

Such machines are generally restricted to obviously projecting vines or canes and do not strip or remove vines or canes which fall close to the plane of the support, merely leaving such canes in the vegetation canopy.

Therefore a need exists for a solution to the problem of pruning or trimming vines or canes which will remove all vines or canes which are not secured to the growth supports and it is an object of the invention to remove from a vegetative canopy vines or canes which have been pruned from the parent stem while leaving those which have not been pruned.

The present invention provides a solution to this and other problems which offers advantages over the prior art or which will at least provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

### SUMMARY OF THE INVENTION

In one exemplification the invention consists in a vine or cane pruning remover having at least two counter-rotating closely abutting linearly aligned vegetation engaging devices, suspension means for the vegetation engaging devices and driving means rotating the vegetation engaging devices.

Preferably the vegetation engaging devices are hydraulically driven wheels with peripheral projections to engage the vines or canes.

Preferably the vegetation engaging devices are hydraulically driven wheels fitted with pneumatic tyres.

Preferably the pneumatic tyres have a distinct tread block pattern.

Preferably the suspension means allows adjustment of the height of the vegetation engaging devices.

Preferably the vegetation engaging devices feed the vegetation into a vegetation mulching device.

Preferably the vegetation mulching device is a flail chopper.

In an alternative embodiment the invention consists in a method of pruning canes or vines comprising providing counter-rotating abutting vegetation engaging devices, bringing the vegetation engaging devices into contact with vegetation to be pruned, engaging the vegetation between the counter-rotating vegetation engaging devices, and pulling the vegetation to be pruned from the parent plant.

Preferably the invention includes feeding the vegetation pruned from the parent plant into an attached mulching or shredding device.

Preferably the counter-rotating abutting vegetation engaging devices are wheels and the invention includes providing vine or cane engaging means on the wheels.

These and other features of as well as advantages which characterise the present invention will be apparent upon reading of the following detailed description and review of the associated drawings.

### BRIEF DESCRIPTION OF THE DRAWINGS

FIG. 1 is a perspective view of a cane or vine pruning remover according to the invention.

FIG. 2 is a top view of the cane or vine pruning remover.

FIG. 3 is an end view of the cane or vine pruning remover.

FIG. 4 is a side view of the cane or vine pruning remover.

FIG. 5 is a perspective view of the pruning remover head without the chute fitted.

FIG. 6 is a pictorial view of the pruning remover in use.

### DESCRIPTION OF THE INVENTION

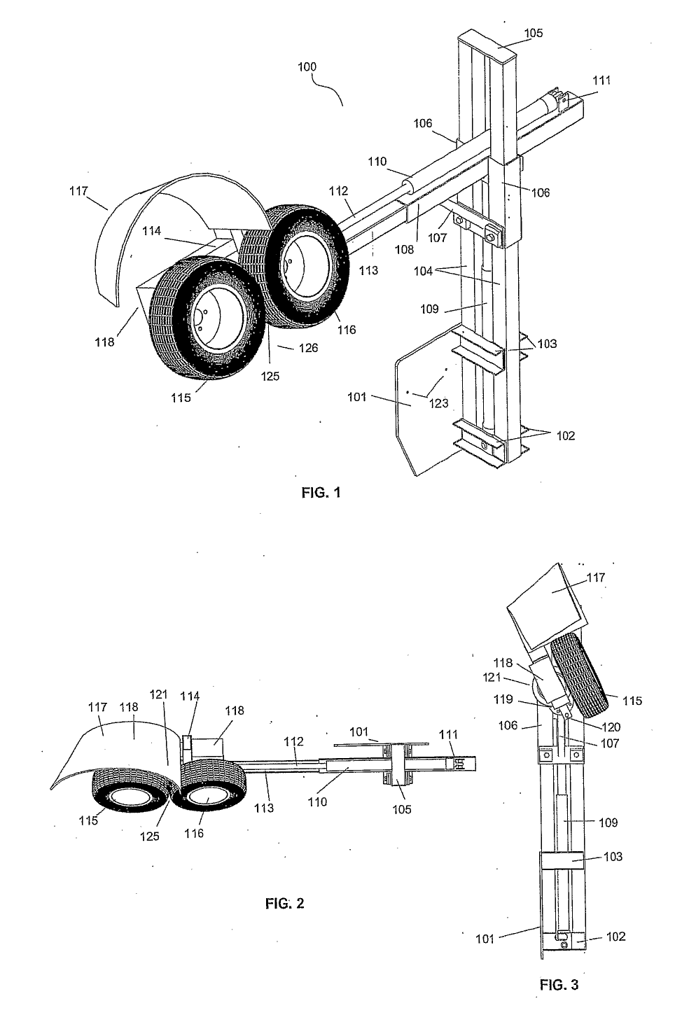

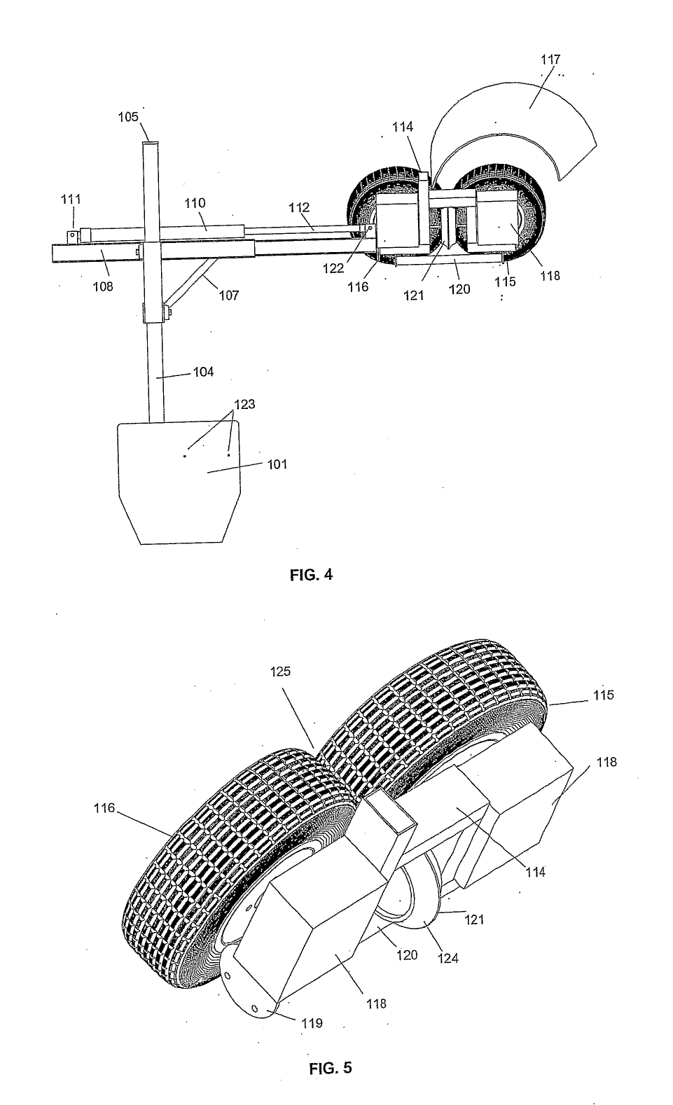

Referring now to FIGS. 1, 2, 3, 4 and 5 these show a cane or vine pruning remover 100 in perspective view at FIG. 1 and consisting of two vegetation engaging wheels 115, 116 mounted on axles of hydraulic motors 118 (FIGS. 3 and 4) which are themselves mounted to a frame 114 spacing the wheels a distance apart which allows them to engage with and grip vines or canes. The wheels may be splayed apart a small amount to allow easy entry of the vines to the area 125 within which the wheels abut. In use the wheels have tread blocks which tend to brush canes or vines into the area of engagement 126 of both wheels.

The wheels counter-rotate so that vegetation is drawn up from below into the area of the abutment 125 between the two wheels and is then ejected into chute 117 and redirected away from the pruning remover.

The frame 114 is supported by an arm 113 which may be moved within sleeve 108 by hydraulic ram 110, 112 which is attached at 111 to the sleeve 108. In this way the position of the wheels may be horizontally adjusted. Sleeve 108 is attached to a height adjustment mechanism consisting of vertical sleeves 106 with a brace 107 to sleeve 108, the whole being slidable on uprights 104 of the support frame. A spacer 105 maintains rigidity at the top of the uprights 104. The lower end of the support frame has channels 103, 104 which are fixed to mounting plate 101. A second hydraulic ram 109 adjusts the vertical position of sleeves 106 on uprights 104 thereby providing height adjustment of the engaging wheels 115, 116.

As best seen in FIG. 3 the wheels 115, 116, hydraulic motors 118 and frame 114 are preferably tilted from the vertical at juncture 119 of the mounting of frame 114 to arm 113 to eject vegetation from the area of the pruning remover. The wheels are also preferably splayed apart by up to 10 degrees in order to provide an easy entry to abutment area 125 for the canes directly in front of the pruning remover. Contact is still maintained between the tyres at the rearward side of the pruning remover. Chute 117 may be of any shape required to direct the vegetation clear or it may be removed. A mulching apparatus (not shown) may replace chute 117 to mulch vegetation ejected from between the wheels.

FIGS. 3, 4 and 5 show an idler wheel 121 whose function is to act as a stop device at the exit area at the side of the two tyres. This is journalled in frame 114 preferably normal to the axis of the wheels. The outer surface 124 of idler wheel 121 is contoured to mate with the contour at the edge of the abutted tyre treads, thus blocking the exit laterally from the abutment area between the two tyres. This ensures that any vine entering the abutment area will be gripped by the wheels and eventually ejected, rather than progressing back through the wheels and tangling in frame 114. As shown idler wheel 121 is not required to be driven, but rotates under the influence of its contact with the tyres, though it could act as the drive source for both tyres.

As best seen in FIG. 4 a rotatable roller 120 extends to one side across the area of entry to the abutment between wheels 115, 116 and serves both to assist in preventing vegetation wrapping about frame 114 and to prevent the entry of any linear supporting framework for the vegetation to the abutment between the wheels.

Mounting plate 101 may be secured at 123 to the back, front or sides of a tractor or other supporting vehicle. Hydraulic hoses for motors and rams are not shown but will typically be connected to the vehicle hydraulic supply and remotely controlled by the vehicle driver.

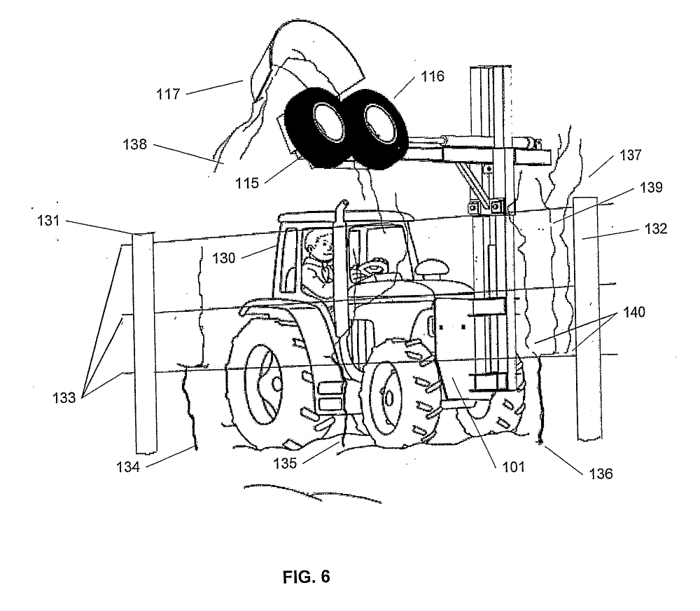

FIG. 6 shows the pruning remover mounted to a tractor 130 and pruning grape vines 134, 135, 136 growing on the trellis wires 133 on posts 131, 132. Foliage vines 137 extending above the level of the top wire 133 are entrained by the counter-rotating wheels 115, 116 into the nip between the wheels and pulled from the trellis, being ejected into chute 117 and deflected at 138 down onto the ground clear of the tractor. Typically next years fruiting canes will have been cut below the uppermost wire at 139 already while the remaining canes and/or cordon have been severed at points 140 on the cordon. The pruning remover will remove all of the current years growth except for the chosen vines, which do not enter the area of entrainment 126 between the wheels.

In use the pruning remover is suspended above the canes or vines with the wheels rotating at up to 300 rpm with an upward direction of travel at the abutment of the wheels. The preferred peripheral speed at the wheel extremity is preferably between 5 and 10 metres per second, most preferably about 7.5 metres per second, in order to attain adequate production speed, although the apparatus will work at lower speeds. The wheels may engage any vines or canes which project far enough above the trellis wires 133. The counter-rotating action tends to push the canes or vines into the engaging nip of the two wheels 115, 116 and once engaged the cane or vine will be pulled upwards until it is pulled from the trellis. The pruning remover may be lowered to the extent that roller 120 (FIG. 4) touches the top trellis wire or posts, with roller 120 preventing entrainment of the wire 133 between the wheels.

Wheels 115, 116 are preferably pneumatic wheels with a pronounced tread block pattern, and the wheels are spaced so that the tread of the two tyres engages to produce the required grip. Other types of wheel or vegetation engaging device than pneumatic tyres may be used and rubber covered rollers or wheels with inter-engaging combs provide a slightly more complex but equally effective solution. Preferably the rotational rate of such equivalents is such that the vines or canes are cleanly pulled from the supporting structure.

A construction in which multiple pruning remover heads are supported from a single support frame 104 is also provided for but not shown, the heads being individually hinged to the sleeve assembly 106 and lowered or lifted by independent hydraulic rams taking the place of brace 107. Such heads may be used to strip canes from two vegetation rows at once, or to strip canes from differing areas of a single vegetation row.

The actual manner in which the rotating wheels or other vegetation engaging devices is supported above the vine trellis is not an essential part of the invention. So long as the wheels can engage at least a portion of the vine to be removed that portion will be removed, and typically adjacent vines will also be drawn into the pruning remover.

The width of the wheels should be sufficient to adequately grip the vines to be pruned, and dual or other multiples of wheels may be provided where a single wheel is not wide enough.

While the drive is described as hydraulic any other drive method may be used, for instance electric or electro-hydraulic.

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example the hydraulic drive for the pruning remover may be varied to an electrical drive without variation in the spirit and scope of the present invention.

In addition, although the preferred embodiments described herein are directed to pruning removers for use in a grape vine pruning machine, it will be appreciated by those skilled in the art that the teachings of the present invention can be applied to other systems such as kiwifruit, without departing from the scope and spirit of the present invention.

### INDUSTRIAL APPLICABILITY

The pruning remover of the invention is used in the cultivation of grape and kiwifruit vines which are employed it the agricultural industry. The present invention is therefore industrially applicable.

1. A vine or cane pruning remover having at least two counter-rotating closely abutting substantially parallel vegetation engaging devices (115, 116) having an abutment zone (125), suspension means (104, 106, 108, 113, 114) for the vegetation engaging devices and driving means (118) rotating the vegetation engaging devices, the vegetation engaging devices defining an engagement area (126) in which vegetation is engaged by at least one of the vegetation engaging devices and moved through the abutment zone (125).

2. A vine or cane pruning remover as claimed in claim 1 wherein the vegetation engaging devices (115, 116) are hydraulically driven wheels with substantially parallel spaced axles the wheels having peripheral projections capable of engaging the vines or canes.

3. A vine or cane pruning remover as claimed in claim 1 wherein the vegetation engaging devices (115, 116) are hydraulically driven wheels fitted with pneumatic tyres and at the abutment zone (125) the tyres engage each other and a stop device (121) preventing exit of vegetation laterally of the tyres.

4. A vine or cane prune pruning remover as claimed in claim 3 wherein the stop device (121) is an idler wheel journalled normal to the abutment zone (125) and contoured to fit the tyre edge profile.

5. A vine or cane prune pruning remover as claimed in claim 2 wherein the pneumatic tyres have a distinct tread block pattern.

6. A vine or cane pruning remover as claimed in claim 2 wherein the vegetation engaging devices (115, 116) are laterally splayed but parallel within 10 degrees.

7. A vine or cane pruning remover as claimed in claim 1 wherein the suspension means (104, 106, 108, 113, 114) allows adjustment of the height of the vegetation engaging devices.

8. A vine or cane pruning remover as claimed in claim 1 wherein the vegetation engaging devices feed the vegetation into a vegetation mulching device.

9. A vine or cane pruning remover as claimed in claim 6 wherein the vegetation mulching device is a flail chopper.

10. A vine or can pruning remover as claimed in claim 1 wherein vegetation ejected from between the vegetation engaging devices is redirected by a chute (117).

11. A vine or cane pruning remover as claimed in claim 3 wherein a transverse stop (120) extending transversely of the area of entry between the counter-rotating wheels (115, 116) prevents entry of an elongate member substantially parallel to the axis of the wheels to the area of abutment (125) between the wheels.

12. A vine or cane pruning remover as claimed in claim 9 wherein the transverse stop (120) is a linear rotating member with its axis normal to the wheel axes.

13. A method of removing pruned canes or vines from a canopy entrained on linear supports (133) comprising providing counter-rotating abutting vegetation engaging devices (115, 116), bringing the vegetation engaging devices into contact with vegetation which has been pruned from the parent plant, engaging the vegetation between the counter-rotating vegetation engaging devices, and pulling the pruned vegetation from the linear supports.

14. A method as claimed in claim 13 which includes separately severing the terminal portion of a vine or cane which it is desired to retain at a point below the uppermost linear support before removing the vegetation to be pruned from a plant.

15. A method of pruning canes or vines as claimed in claim 13 wherein the method includes feeding the vegetation pruned from the parent plant into an attached mulching or shredding device.

16. A method of pruning canes or vines as claimed in claim 13 wherein the counter-rotating abutting vegetation engaging devices (115, 166) are wheels and including providing a stop device (121) laterally of the wheels thereby preventing the lateral exit of vegetation from between the wheels.

17. A method of pruning canes or vines as claimed in claim 16 wherein the stop device is an idler wheel (121) contoured to engage the lateral face of the wheels.
